(19) United States
(12) Patent Application Publication
(10) Pub. No.: US 2007/0079140 A1
(43) Pub. Date: Apr. 5, 2007

(54) Data migration

(76) Inventors: Brian Metzger, San Jose, CA (US); Stephen Mauldin, San Francisco, CA (US); Bruce Sandell, Mountain View, CA (US); Jorge Chang, Santa Clara, CA (US)

Correspondence Address: PERKINS COIE LLP, P.O. BOX 2168, MENLO PARK, CA, 94026, US

(21) Appl. No.: 11/236,294

(22) Filed: Sep. 26, 2005

(51) Int. Cl. G06F 12/14

(52) U.S. Cl. 713/189

(57) ABSTRACT

A system and method for providing a mechanism for automating the conversion of the relational database to a secure relational database with little or no impact on the resources of the relational database during the conversion.

### CROSS-REFERENCE TO RELATED APPLICATIONS

The present application is related to the following applications that are concurrently filed and the entire contents of which are hereby incorporated by reference as if fully set forth herein. The related concurrently filed applications are: TRANSPARENT ENCRYPTION USING SECURE ENCRYPTION DEVICE by inventors, Brian Metzger, Bruce Sandell, Stephen Mauldin, and Jorge Chang filed on Sep. 26, 2005; and KEY ROTATION by inventors, Brian Metzger, Bruce Sandell, Stephen Mauldin, and Jorge Chang filed on Sep. 26, 2005.

### TECHNICAL FIELD

The present invention is directed to data security, and more specifically to protecting sensitive data that resides in a database and providing a mechanism for automating the conversion of the database to a secure database with little or no impact on the resources of the database during the conversion.

### BACKGROUND

It cannot be gainsaid that confidential information, such as credit card numbers, social security numbers, patient records, insurance data, etc., need to be protected.

Although enterprises have instituted procedures for protecting such sensitive data when such data is in transit, more often than not, such data is stored in unencrypted format (“clear text” or “plain text”). For example, data is often stored as clear text in databases. The clear text is visible to attackers and disgruntled employees who can then compromise the data and/or use the data illegitimately. Further, not only is data security a feature that is highly desired by customers but it is also needed to comply with certain data security regulations. In order to adequately protect data, organizations need to institute procedures to protect data at all times including when the data is in storage, when the data is in transit, and when the data is being used.

However, in order to convert existing databases into a secure system, vast computing resources are required because large volumes of data need to be converted. It is desirable to make the conversion so as to not drain the computing and storage resources of the target relational database. It is also desirable to make the conversion as transparent and convenient as possible for the administrator of the target database.

### BRIEF DESCRIPTION OF THE DRAWINGS

FIG. 1 is a high-level block diagram that illustrates system architecture for encryption of data in a database using an encryption mechanism that is separate from the database, according to certain embodiments.

FIG. 2 is a flowchart that illustrates some of the steps that are performed for converting sensitive data that is stored in clear text format in a target relational database into encrypted format in a manner that has minimal impact on the resources of the target relational database.

FIG. 3 is a non-limiting high-level example of a data migration script for a SQL Server type DBMS.

FIG. 4 is a non-limiting high-level example of a data migration script for a DB2 Server type DBMS.

### DETAILED DESCRIPTION

According to certain embodiments, an unsecured relational database system is converted to a secure system by providing mechanisms for converting existing data that resides in the relational database into encrypted format with minimal impact to the resources of the relational database.

According to certain embodiments, a mechanism that is used for migrating target data for encryption from the target database includes the following functionality: 1) identify which tables a user is authorized to modify, 2) determine which columns, in the identified tables, that the user is authorized to encrypt, 3) accept input parameters for specifying the characteristics of the desired encryption, 4) modify or create column lengths and data types as required for each column that is targeted for encryption, 5) encrypt clear text data that is present in each column that is targeted for encryption, and 6) provide an “undo” functionality for restoring an encrypted column to its original size and data type as well as restore the target data to its unencrypted form.

According to certain embodiments, a mechanism is provided to allow the encryption of the target data to occur on a device that is separate from the relational database so as to not drain the computing and storage resources of the relational database. Such a mechanism can include a management console for managing the migration of data from the target database to the encryption server for processing.

According to certain embodiments, the database data that is targeted for encryption is performed on a specialized piece of hardware that is designed to rapidly perform data encryption on large volumes of data from the relational database that is targeted for conversion to a secure system. Further, such a specialized piece of hardware is equipped with its own CPU and processing power in order to offload the database server that is associated with the target relational database.

According to certain embodiments, a mechanism that is separate from the relational database and that is used for encrypting target data stores cryptographic keys in a highly secure manner so as to be inaccessible to non-authenticated processes.

According to certain embodiments, a mechanism that is separate from the target relational database issues a select statement to retrieve target data from the target relational database. Such a mechanism then performs multithreaded, hardware level encryption on the target data. After the target data is encrypted, the mechanism issues an update statement to copy the encrypted data back into the target relational database.

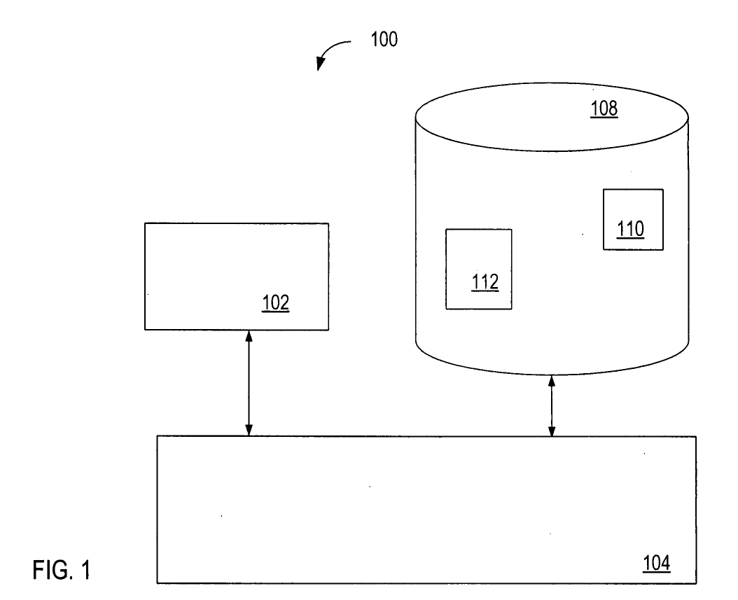

FIG. 1 is a high-level block diagram that illustrates system architecture for encryption of data in a database using an encryption mechanism that is separate from the database, according to certain embodiments. In architecture 100, a client computer 102 is capable of communicating with a cryptography server 114. Cryptography server communicates with relational database 108. Cryptography server includes, among other components, a CPU and processing power. The cryptography server can be used for storing information that includes but is not limited to information on database connection and access privileges to encrypted data. Cryptography server 114 is also referred to as a network-attached cryptography server (NAE server).

Relational database 108 includes, among other components, a plurality of data tables such as table 110 and a plurality of metadata tables such as metadata table 112. The metadata tables in the relational database can be used for storing information that includes but is not limited to 1) each authorized user's access rights with respect to database tables and columns managed by the relational database, and 2) database table and column schema, 3) information on encryption methods, and 4) information on properties of tables and columns that are selected for encryption from the target database. The cryptography server retrieves target data from the selected target relational database. The cryptography server then performs encryption on the target data. According to certain embodiments, the cryptography server then performs multithreaded, hardware level encryption on the target data.

A user such as a security administrator or database administrator can use a client computer to manage the encryption process of data in the relational database by accessing a data management console associated with the cryptography server. According to certain embodiments, the data management console allows the user to login to a desired database server and communicate with the database. In certain other embodiments, the desired relational database may include a database provider and cryptography provider. According to certain embodiments, the database provider is a computer-implemented functionality of the relational database server and can communicate with the cryptography server. The cryptography provider communicates with the cryptography server to request for cryptography services. The cryptography provider is the API to the cryptography server, according to certain embodiments.

According to certain embodiments, the cryptography server, such as the NAE server, manages cryptography operations and encryption key management operations.

The cryptography server allows a user or cryptography server client to perform cryptography operations including operations associated with the encryption and decryption of data, encryption keys, authentication, creation of digital signatures, generation and verification of Message Authentication Code (MAC).

According to certain embodiments, the cryptography server includes a data migration tool that includes the following functionality: 1) identify which tables a user is authorized to modify, 2) determine which columns, in the identified tables, that the user is authorized to encrypt, 3) accept input parameters for specifying the characteristics of the desired encryption, 4) modify or create column lengths and data types as required for each column that is targeted for encryption, 5) encrypt clear text data that is present in each column that is targeted for encryption, and 6) provide an “undo” functionality for restoring an encrypted column to its original size and data type as well as restore the target data to its unencrypted form.

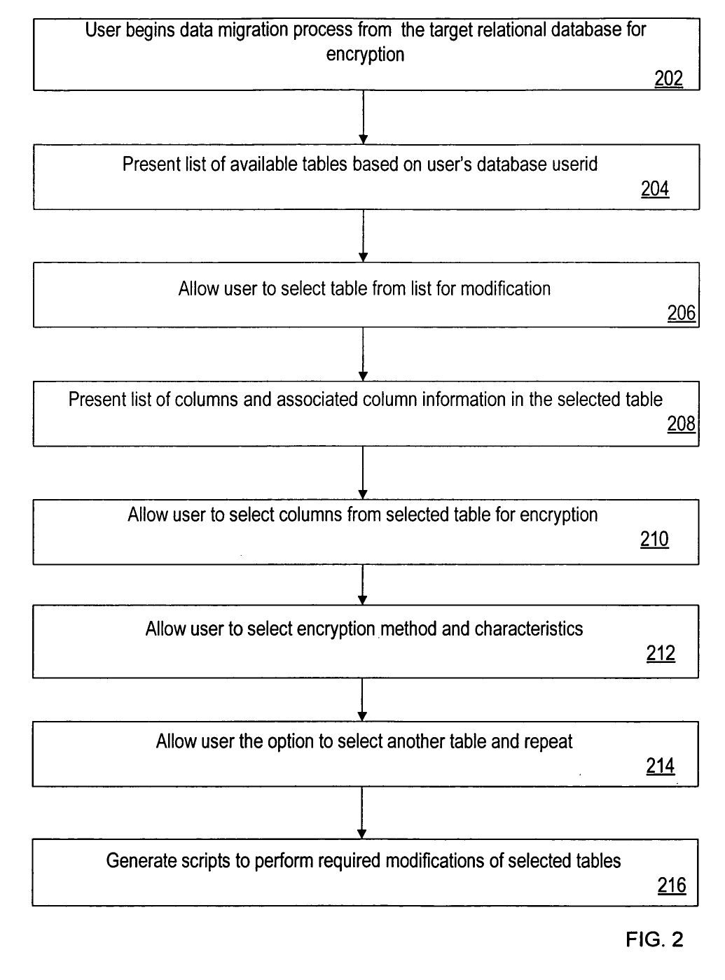

FIG. 2 is a flowchart that illustrates some of the steps that are performed for converting sensitive data that is stored in clear text format in a target relational database into encrypted format in a manner that has minimal impact on the resources of the target relational database.

At block 202 of FIG. 2, a user, such as a security administrator, begins the data migration of selected sensitive data (also referred to as target data) from the target relational database for purposes of encryption. According to certain embodiments, the user can begin the data migration by accessing a cryptography server, such as cryptography server 104 of FIG. 1. According to certain embodiments, the cryptography server may include a data migration tool with a front-end user interface. The front-end user interface of such a data migration tool is herein also referred to as a data management console. The data management console allows the user to enter a specific set of data that is required to login to the target database. The specific set of data that is required for logging in may vary based on the database vendor. Thus, according to certain embodiments, the management console allows the user to specify the database type of the target database. Based on the database type, the management console can then present the login data fields for logging into the target database.

When the user's login information is submitted, an attempt to connect to the target database server is initiated. According to certain embodiments, if the connection attempt is successful, the database connection information is stored on the cryptography server. Such database connection information can be collected and stored for each type of database so that during future login attempts, the user can be presented with a login screen that requires a minimum amount of data entry for a selected target database.

If the connection attempt to connect with to the target database is unsuccessful, then the user may be presented with an error message and is allowed to reenter login information.

At block 204 of FIG. 2, once connected to the target database, the management console can then present a list of database tables that are available to the user for modification, according to certain embodiments. According to certain embodiments, database metadata tables, such as metadata table 112, are queried based on the user's user id. Such metadata tables store information on the database tables that reside in the target database. The database metadata tables are queried based on user id in order to determine a list of database tables that the user is authorized to access and modify. The list of database tables that the user is authorized to access and modify is herein referred to as an accessible list of database tables. The accessible list of database tables is returned to the management console for presenting to the user.

At block 206 of FIG. 2, the user can select a database table from the accessible list of database tables for migration and subsequent modification. The database table that is selected by the user is herein referred to as the selected database table. The selected database table is sometimes referred to herein as a base table. At block 208 of FIG. 2, a list of columns is presented to the user. According to certain embodiments, the database metadata tables are queried based on the user's user id to determine the list of columns that are available to the user for modification in the selected database table. The list of columns in the selected database table that the user is authorized to access and modify is herein referred to as an accessible list of columns.

The accessible list of columns is returned to the management console for presenting to the user. According to certain embodiments, in addition to determining the accessible list of columns, the database metadata tables and the encryption information stored on the cryptography server can be queried to determine certain information on the columns that may be useful to the user. The information on the columns that may be useful to the user is herein referred to as column information. The column information can help the user decide whether to accept or reject the column as a candidate for encryption.

The column information is returned to the management console for presenting to the user. Such column information may vary from implementation to implementation. Some non-limiting examples of column information relate to: 1) whether a column has a data type that is supported (the user is advised to reject columns with non-supported data types as candidates for encryption), 2) whether a column is used as a primary key (the user is informed that a primary key column may be encrypted if such a column is not referenced as a foreign key, either explicitly or implicitly), 3) whether a column is used as a foreign key (the user is advised to reject columns that are used as foreign keys as candidates for encryption), 4) whether a column is used in an index (the user is advised that the sort order of encrypted data will not be consistent with the sort order of clear text data), 5) whether a column has a default value assigned to it (the user is advised to reject columns that have default value assigned to them as candidates for encryption), 6) whether a column has a check constraint (the user is advised to reject columns that have check constraints as candidates for encryption), 7) whether a column is referenced in any triggers on the database table in which the column resides (the user is advised to review the trigger(s) to see if the trigger(s) will function as expected), and 8) whether a column is in encrypted format (the user is advised to reject columns that are already encrypted as candidates for encryption). One or more of the above non-limiting examples of column information may involve manual checks, according to certain embodiments.

At block 210 of FIG. 2, the user is allowed to select the columns for encryption from the target database (base table). At block 212, the user is allowed to select the encryption method and the associated encryption characteristics for the selected columns. For example, the user may be allowed to select the encryption algorithm, mode, initialization vector, and padding. According to certain embodiments, the user's choices may be stored in the cryptography server for future reference.

At block 214 of FIG. 2, the user is allowed to select another table for encryption and the above process is repeated. At block 216, after the user has completed his or her selection of tables and columns for encryption, scripts may be generated to automatically perform the data migration of the user's selected tables and columns and other necessary modification. An example of one of the functions of the scripts is the modification of column sizes based on the selected encryption algorithm and selected encryption characteristics so as to accommodate the target after the target data is encrypted. The set of scripts may vary for each type of relational database. Each type of database management system may support varying functionalities. Thus, the process for data migration may be tailored to each type of database management system (DBMS).

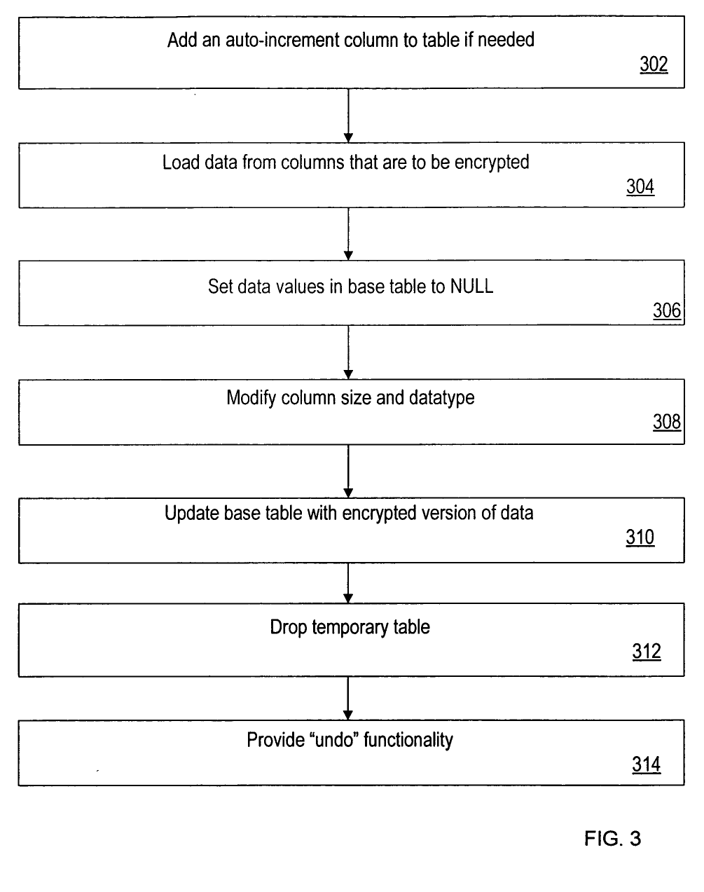

FIG. 3 is a non-limiting high-level example of a data migration script for a SQL Server type DBMS. At block 302, an identity column is added to the base table from which columns are selected for encryption if such an identity column does not already exist.

At block 304, data from the columns that are selected for encryption from the base table referenced in block 302 are loaded into a temporary table, along with the identity referenced in block 302 and an incremented row counter. According to certain embodiments, the incremented row counter can be used to support user-specified batch sizes for processing. The loaded data in the temporary table is then encrypted by the cryptography server using the selected encryption method, mode, initialization vector and padding, if applicable.

At block 306, the data values corresponding to the columns selected for encryption in the base table referenced in block 302 are set to NULL. The data values are set to NULL in order to modify the corresponding column size and datatype.

At block 308, the column size and datatype of the columns selected for encryption are modified in order to support the selected encryption algorithm and padding.

At block 310, the base table referenced in block 302 is updated with the encrypted version of the data from the temporary table referenced in block 304 by calling one of the TSQL encryption procedures.

At block 312, the temporary table referenced in block 304 is dropped after the data encryption process is complete and validated. At block 314, an “undo” functionality is provided for reversing the encryption process as described with reference to FIG. 3 so as to return the base table or any specified columns to its original unencrypted form, if reversal is indeed desired.

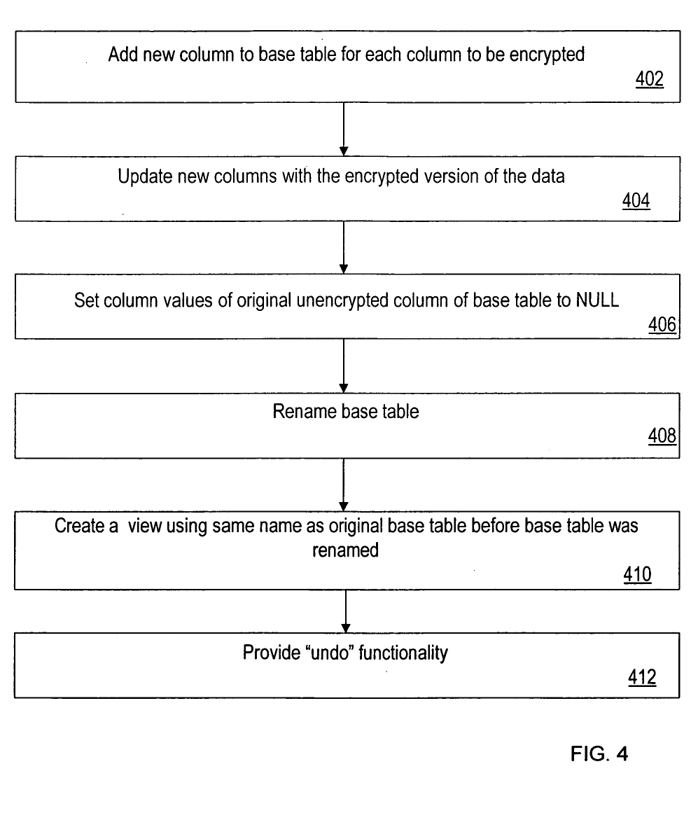

FIG. 4 is a non-limiting high-level example of a data migration script for a DB2 Server type DBMS. At block 402, for each column of data selected for encryption, a new column is added to the base table from which columns are selected for encryption. At block 404, the selected column data is encrypted by the cryptography server and the new columns referenced in block 402 are updated with the encrypted version of the column data.

At block 406, the column values of the original unencrypted data are set to NULL. At block 408, the base table referenced in block 402 is renamed in order to create a view of the base table with the same original name. At block 410, a view is created on the base table referenced in block 408 with the same name as the base table before the base table was renamed. At block 412, an “undo” functionality is provided for reversing the encryption process as described with reference to FIG. 4 so as to return the base table or any specified columns to its original unencrypted form, if reversal is indeed desired.

In the foregoing specification, embodiments of the invention have been described with reference to numerous specific details that may vary from implementation to implementation. The specification and drawings are, accordingly, to be regarded in an illustrative rather than a restrictive sense.

We claim:

1. A computer-implemented method for encrypting data from a database, said method comprising:
providing a mechanism having computing resources that is divorced from resources of said database for performing encryption operations;
providing an automated tool that is associated with said mechanism for:
selecting target data for encryption;
selecting an encryption method for said target data;
specifying one or more characteristics for said selected encryption method; and
modifying a corresponding schema for each database column where said target data resides in a manner for accommodating said target data after said target is encrypted.

2. The computer-implemented method of claim 1, further comprising providing a functionality for restoring said each database column to its original size and data type.

3. The computer-implemented method of claim 1, further comprising determining which data in said database can be modified by a user based on said user's access rights to said database.

4. The computer-implemented method of claim 3, further comprising identifying which database tables in said database can be modified by said user.

5. The computer-implemented method of claim 4, further comprising determining which columns in said identified database tables can be modified by said user.

6. The computer-implemented method of claim 1, further comprising encrypting said target data using said selected encryption method.

7. The computer-implemented method of claim 1, further comprising restoring said target data to its original unencrypted form after said target data is encrypted.

8. The computer-implemented method of claim 1, further comprising providing a management console with a graphical user interface for using said automated tool.

9. The computer-implemented method of claim 8, wherein said interface is web-based.

10. The computer-implemented method of claim 1, wherein said one or more characteristics for said selected encryption method comprises an encryption algorithm type, a mode type, a padding and an initialization vector.

11. The computer-implemented method of claim 10, wherein said encryption algorithm type includes DES, DESede, AES, RC4, HMAC, RSA.

12. The computer-implemented method of claim 10, wherein said mode type includes CBC mode and EBC mode.

13. An encryption system for encrypting data in a database, the encryption system comprising:
a means for selecting target data for encryption;
a means for selecting an encryption method for said target data;
a means for specifying one or more characteristics for said selected encryption method; and
a means for modifying a corresponding schema for each database column where said target data resides in a manner for accommodating said target data after said target is encrypted.

14. The encryption system of claim 13, further comprising a means for providing a functionality for restoring said each database column to its original size and data type.

15. The encryption system of claim 13, further comprising a means for determining which data in said database can be modified by a user based on said user's access rights to said database.

16. The encryption system of claim 15, further comprising a means for identifying which database tables in said database can be modified by said user.

17. The encryption system of claim 16, further comprising a means for determining which columns in said identified database tables can be modified by said user.

18. The encryption system of claim 13, further comprising a means for encrypting said target data using said selected encryption method.

19. The encryption system of claim 13, further comprising a means for restoring said target data to its original unencrypted form after said target data is encrypted.

20. An apparatus for encrypting data in a database, the apparatus comprising:
one or more processors;
a storage for encryption keys;
an authentication mechanism for authenticating users who desire to access said database;
a database interface for interfacing with said database;
a management console for allowing an administrator to manage said data in said database;
a storage medium carrying one or more sequences of one or more instructions which, when executed by said one or more processors, cause said one or more processors to perform the steps of:
selecting target data for encryption;
selecting an encryption method for said target data;
specifying one or more characteristics for said selected encryption method; and
modifying a corresponding schema for each database column where said target data resides in a manner for accommodating said target data after said target is encrypted.

21. The apparatus of claim 20, further comprising a first mechanism for restoring said each database column to its original size and data type.

22. The apparatus of claim 20, further comprising a second mechanism for determining which data in said database can be modified by a user based on said user's access rights to said database.

23. The apparatus of claim 22, further comprising a third mechanism for identifying which database tables in said database can be modified by said user.

24. The apparatus of claim 23, further comprising a fourth mechanism for determining which columns in said identified database tables can be modified by said user.

25. The apparatus of claim 20, further comprising a fifth mechanism for encrypting said target data using said selected encryption method.

26. The apparatus of claim 20, further comprising a sixth mechanism for restoring said target data to its original unencrypted form after said target data is encrypted.

27. One or more propagated data signals collectively conveying data that causes a computing system to perform a method for encrypting data from a database, said method comprising:
providing a mechanism having computing resources that is divorced from resources of said database for performing encryption operations;
providing an automated tool that is associated with said mechanism for:
selecting target data for encryption;
selecting an encryption method for said target data;
specifying one or more characteristics for said selected encryption method; and
modifying a corresponding schema for each database column where said target data resides in a manner for accommodating said target data after said target is encrypted.

28. The propagated data signals of claim 27, further comprising providing a functionality for restoring said each database column to its original size and data type.

29. The propagated data signals of claim 27, further comprising determining which data in said database can be modified by a user based on said user's access rights to said database.

30. The propagated data signals of claim 29, further comprising identifying which database tables in said database can be modified by said user.

31. The propagated data signals of claim 30, further comprising determining which columns in said identified database tables can be modified by said user.

32. The propagated data signals of claim 27, further comprising encrypting said target data using said selected encryption method.

33. The propagated data signals of claim 27, further comprising restoring said target data to its original unencrypted form after said target data is encrypted.

34. The propagated data signals of claim 27, further comprising providing a management console with a graphical user interface for using said automated tool.

35. The propagated data signals of claim 34, wherein said interface is web-based.

36. The propagated data signals of claim 27, wherein said one or more characteristics for said selected encryption method comprises an encryption algorithm type, a mode type, a padding and an initialization vector.

37. The propagated data signals of claim 36, wherein said encryption algorithm type includes DES, DESede, AES, RC4, HMAC, RSA.

38. The propagated data signals of claim 36, wherein said mode type includes CBC mode and EBC mode.
